(19) United States
(12) Patent Application Publication
(10) Pub. No.: US 2015/0091461 A1
(43) Pub. Date: Apr. 2, 2015

(54) Power Supply Device and Lighting Device

(71) Applicant: TOSHIBA LIGHTING & TECHNOLOGY CORPORATION, Yokosuka-shi (JP)

(72) Inventors: Hiroto Nakamura, Yokosuka-shi (JP); Go Kato, Yokosuka-shi (JP); Naoko Iwai, Yokosuka-shi (JP)

(73) Assignee: TOSHIBA LIGHTING & TECHNOLOGY CORPORATION, Yokosuka-shi (JP)

(21) Appl. No.: 14/200,043

(22) Filed: Mar. 7, 2014

(30) Foreign Application Priority Data
Sep. 27, 2013 (JP) 2013-202143

(51) Int. Cl. H02M 7/04; H05B 33/08

(52) U.S. Cl. CPC H02M 7/04; H05B 33/0815
USPC 315/200 R; 363/84

(57) ABSTRACT

According to one embodiment, there is provided a power supply device which includes a power conversion circuit which outputs an input power to an LED element as a load by converting the input power into a predetermined output power; and a control circuit which performs a feedback control of the power conversion circuit by detecting the output power of the power conversion circuit, and performs a dimming control which causes the LED element to be subject to a dimming operation based on a dimming signal which is output from a dimmer, in which, when a dimming OFF signal is input, the power conversion circuit outputs power which causes the LED element to be turned off while continuing an operation of the power conversion circuit.

### CROSS-REFERENCE TO RELATED APPLICATIONS

This application is based upon and claims the benefit of priority from the prior Japanese Patent Application No. 2013-202143, filed on Sep. 27, 2013, the entire contents of which are incorporated herein by reference.

### FIELD

Embodiments described herein relate generally to a power supply device which supplies power to a load, and a lighting device.

### BACKGROUND

In a power supply device of the related art which has an LED element as a load, for example, an AC power supply is rectified in a rectifying circuit, a rectified power supply voltage is supplied to the LED element by being converted into a predetermined DC voltage in a power conversion circuit, and the LED element is turned on.

A feedback control in which, in order to make turning on of the LED element stable, an output of the power conversion circuit is detected, the output is compared with a target value, and the detection value caused to be close to the target value based on a comparison result is frequently adopted in the power conversion circuit.

On the other hand, when the LED element is subject to a dimming operation, it is possible to perform the dimming operation corresponding to a dimming signal when a dimming control circuit which receives the dimming signal which is output from a dimmer outputs a dimming control signal to a control circuit of the power conversion circuit.

The dimming control is a control in which an output of the power conversion circuit is controlled so that the LED element performs a dimming operation from lights out (0% lighting) to 100% lighting continuously or in stages.

When a dimming OFF signal is input to the dimming control circuit, a dimming control signal is output to a control circuit so that an operation of the power conversion circuit is stopped in order to turn off the LED element, a power supply to the control circuit is interrupted, and the operation of the power conversion circuit is stopped.

When a dimming ON signal (for example, 50% lighting) is re-input after stopping the operation of the power conversion circuit, there is a case in which an overshoot phenomenon that the LED element is brightly turned on in an instant by exceeding a dimming level corresponding to the dimming ON signal occurs. The reason is that an excess current is output from the power conversion circuit, since there is a big difference between a target value and an output detection value when the power supply to the control circuit is restarted, the control circuit is started up, and the feedback control is started.

### BRIEF DESCRIPTION OF THE DRAWINGS

FIG. 1 is a circuit diagram of a power supply device according to one embodiment.

FIG. 2 is a tinning chart which illustrates a starting operation of the power supply circuit.

FIG. 3 is a tinning chart which illustrates an input of a dimming signal of the power supply circuit and an output of a load.

### DETAILED DESCRIPTION

In view of the above circumstances, an object of the embodiment is to provide a power supply device and a lighting device which can perform lighting at a desired dimming level without an overshoot phenomenon even when an operation of a power conversion circuit is stopped due to an input of a dimming OFF signal, and then a dimming ON signal is re-input.

In general, according to one embodiment, there is provided a power supply device which includes a power conversion circuit which outputs an input power to a load by converting the input power into a predetermined output power; and a control circuit which performs a feedback control of the power conversion circuit by detecting the output power of the power conversion circuit, and performs a dimming control which causes the load to be subject to a dimming operation based on a dimming signal which is output from a dimmer, in which, when a dimming OFF signal is input, the power conversion circuit outputs power which causes the load to be turned off while continuing an operation of the power conversion circuit.

According to the embodiment, since the power conversion circuit outputs power which causes the load to be turned off while continuing the operation thereof when the dimming OFF signal is input, even when a dimming ON signal is re-input, it is possible to maintain stable control, when a difference between a target value and an output detection value in the feedback control of the control circuit is in a predetermined range, and to promptly perform a dimming operation based on a dimming signal.

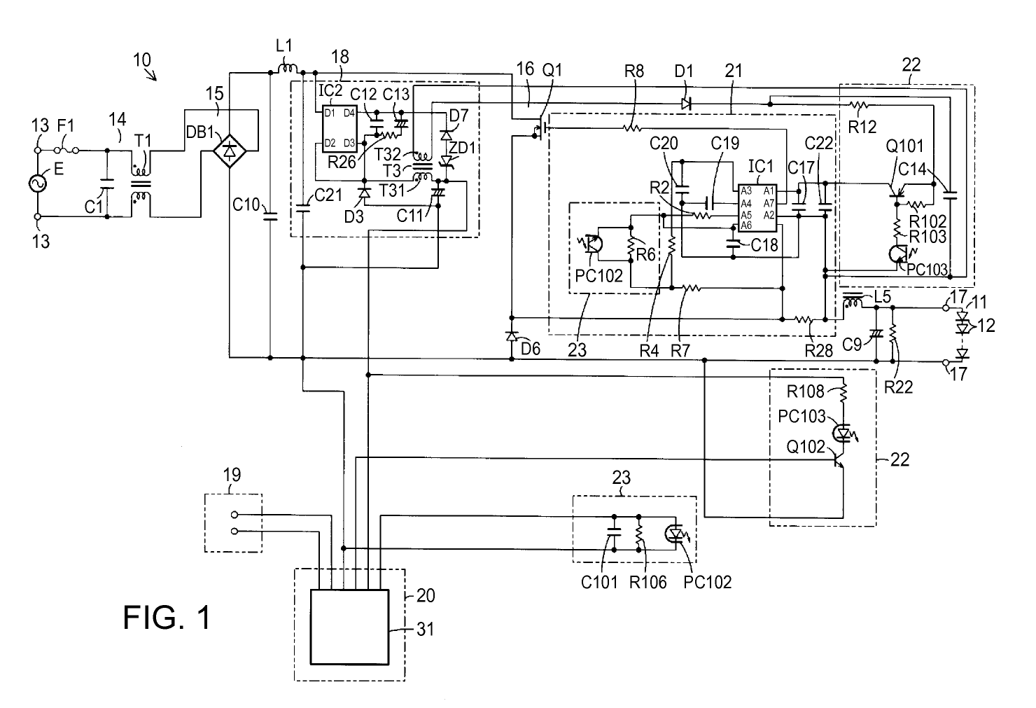

Hereinafter, an embodiment will be described with reference to FIG. 1.

A power supply device 10 causes a plurality of LED elements 12 which are connected in series as a load 11 to be turned on. The power supply device 10 includes a power supply input unit 13 to which an AC power supply E is input, a filter circuit 14 which is connected to the power supply input unit 13, a rectifying circuit 15 which rectifies the AC power supply E by being connected to the filter circuit 14, a power conversion circuit 16 as a main circuit which converts a power supply voltage which is rectified in the rectifying circuit 15 into a predetermined output power which causes the LED element 12 to be turned on, and an output unit 17 which is an output unit of the power conversion circuit 16, and to which the LED element 12 is connected.

In addition, the power supply device 10 includes a power supply circuit 18 which supplies a power source for controlling, a dimming signal input unit 19 which inputs a dimming signal, a first control circuit 20 as a dimming control circuit which processes the dimming signal, a second control circuit 21 as a control circuit for controlling the power conversion circuit 16, a operation control circuit 22 which controls an operation and a stop of the second control circuit 21, and a dimming operation circuit 23 which causes the second control circuit 21 to perform a dimming operation using a control of the first control circuit 20.

In addition, the power supply input unit 13 allows an input of an AC power supply E in a range of 100 V to 242 V, for example.

In addition, in the filter circuit 14, a capacitor C1 and a transformer T1 are connected to the power supply input unit 13 through a fuse F1.

In addition, a full-wave rectifier DB1 is used in the rectifying circuit 15. A capacitor C10 is connected to an output end of the full-wave rectifier DB1 in parallel.

In addition, the power conversion circuit 16 is a step-down chopper circuit, and a field effect transistor Q1 which is a MOSFET as a switching element, a resistor R28, an inductor L5, and the LED element 12 of the output unit 17 are connected to the output end of the full-wave rectifier DB1 through an inductor L1. A resistor R22 and an electrolytic capacitor C9 are connected to the output unit 17 in parallel.

A cathode of a diode D6 is connected between a source of the field effect transistor Q1 and the inductor L5, and an anode of the diode D6 is connected to a ground potential side of the LED element 12 and an electrolytic capacitor C9. The diode D6 has an operation of discharging energy which is accumulated in the inductor L5 when the field effect transistor Q1 is OFF through the LED element 12 and the electrolytic capacitor C9.

In addition, in the power supply circuit 18, a capacitor C21 is connected to an output end on the high potential side of the full-wave rectifier DB1 through the inductor L1, and a ground potential side of the capacitor C21 is connected to the first control circuit 20. A terminal D1 of a control unit IC2 is connected to the inductor L1, and a terminal D2 of the control unit IC2 is connected to the first control circuit 20 through primary winding T31 of a transformer T3. A cathode of a diode D3 and one end of an electrolytic capacitor C11 are connected to both ends of the primary winding T31. An anode of the diode D3 and the other end of the electrolytic capacitor C11 are connected between the capacitor C21 and a ground potential side of the full-wave rectifier DB1.

A capacitor C12, an electrolytic capacitor C13, and a series circuit of a resistor R26 are connected in parallel between terminals D4 and D3 of the control unit IC2, a cathode of a diode D7 is connected to an electrolytic capacitor C13, an anode of a zener diode ZD1 is connected to an anode of the diode D7, and a cathode of the zener diode ZD1 is connected to an electrolytic capacitor C11.

In addition, the control unit IC2 is an intelligent power device (IPD), for example, includes a switching element therein, converts a power supply voltage which is input to the control unit IC2 due to a switching operation of the switching element into a predetermined first control power supply, and the first control power supply of which a ground potential is common to that of the power conversion circuit 16 is supplied to the first control circuit 20 through the primary winding T31 of the transformer T3.

In a secondary winding T32 which is insulated with respect to the primary winding T31 of the transformer T3, and is magnetically coupled thereto, a second control power supply is induced when the first control power supply flows to the primary winding T31, and the second control power supply having an arbitrary ground potential which is different from the ground potential of the power conversion circuit 16 is supplied to the second control circuit 21 through the operation control circuit 22.

In addition, a dimming signal is input to the dimming signal input unit 19 from a dimmer which is provided outside.

The first control circuit 20 as the dimming control circuit includes a microcomputer 31, and is operated when a first control power supply of which a ground potential is common to that of the power conversion circuit 16 is supplied from the power supply circuit 18. The microcomputer 31 performs processing according to a dimming signal from the dimmer, forms a dimming control signal such as a PWM dimming control signal corresponding to the dimming signal, for example, and outputs the signal to the operation control circuit 22, and controls a dimming operation of the second control circuit 21 by outputting the signal to a dimming operation circuit 23.

In addition, the second control circuit 21 includes a control circuit IC1, and the second control power supply having an arbitrary ground potential which is different from the ground potential of the power conversion circuit 16 is supplied to a VCC terminal of the control unit IC1 from the power supply circuit 18 through the operation control circuit 22. A GND terminal is connected to one end of the inductor L5 on the field effect transistor Q1 side, and makes a middle point potential of the power conversion circuit 16 be grounded. The capacitors C17 and C22 are connected in parallel between a VCC output terminal A1 and a GND terminal A2.

A terminal A3 of the control unit IC1 is connected between a cathode of the diode D6 and the inductor L5 through the resistors R4 and R7, and is input with a detection voltage corresponding to an output current of the power conversion circuit 16.

The terminal A4 of the control unit IC1 is connected to a connection point of a resistor 28 which will be described later and the inductor L5 through the capacitor C19.

A capacitor C20 is connected between a terminal A3 of the control unit IC1 and the GND terminal A2. A resistor R2 is connected between a terminal A5 and the dimming operation circuit 23. A capacitor C18 is connected between a terminal A6 and the GND terminal A2.

A terminal A7 of the control unit IC1 is connected to the gate of the field effect transistor Q1 through a resistor R8.

In addition, the control unit IC1 includes an operational amplifier therein, and is input with a predetermined reference voltage as a target value at one input terminal of the operational amplifier, is input with a detection voltage corresponding to the output current of the power conversion circuit 16 as an output detection value from a terminal A3 to the other input terminal, a current corresponding to a difference between the reference voltage and the detection voltage is output from a terminal A4, and ON and OFF of the field effect transistor Q1 is controlled in a feedback manner so that the detection voltage input to the terminal A3 becomes constant. That is, the terminal A3 is an input terminal of the operational amplifier, and the terminal A4 is an output terminal of the operational amplifier.

In addition, in the operation control circuit 22, one end of a secondary winding T32 of the transformer T3 of the power supply circuit 18 is connected to the VCC output terminal A1 of the control unit IC1 through the diode D1 and a resistor R12, and the other end of the secondary winding T32 is connected to the GND terminal A2 of the control unit IC1. A capacitor C14 is connected between both ends of the secondary winding T32. A resistor R102 is connected between an emitter and a base of a transistor Q101. The base of the transistor Q101 is connected with a resistor R103, and the GND terminal A2 of the control unit IC1 through a photo transistor of a photo coupler PC103 as an insulation transmission element for controlling operation.

A series circuit of a resistor R108, a photodiode of the photo coupler PC103, a collector and an emitter of a transistor Q102 are connected between the primary winding T31 side of the transformer T3 which supplies the first control power supply of the power supply circuit 18 and the ground potential of the power conversion circuit 16, and the photodiode of the photo coupler PC103 is connected thereto. A base of the transistor Q102 is connected to a terminal which outputs the operation or stop signal from the microcomputer 31 of the first control circuit 20.

In addition, when the transistor Q102 is turned ON and OFF according to the operation and stop signals from the microcomputer 31, the photo coupler PC103 is turned ON and OFF. When the photo coupler PC103 is turned off, the transistor Q102 is turned OFF, and the second control power supply is supplied to the second control circuit 21 from the power supply circuit 18, and when the photo coupler PC103 is turned on, the transistor Q102 is turned on, and the supply of the second control power supply to the second control circuit 21 is stopped.

In addition, the dimming operation circuit 23 includes a photo coupler PC102 as an insulation transmission element for dimming, and a photodiode of the photo coupler PC102 is connected between a terminal which outputs a dimming signal from the microcomputer 31 of the first control circuit 20 and the ground potential of the power conversion circuit 16. A capacitor C101, and a resistor R106 are connected to the photodiode of the photo coupler PC102 in parallel.

A resistor R6 is connected in parallel to a collector and an emitter of a photo transistor of the photo coupler PC102, one end of the resistor R6 is connected to the terminal A5 of the control unit IC1 through the resistor R2, and the other end is connected between the resistor R4 and the resistor R7 of the second control circuit 21.

Subsequently, operations of the power supply device 10 will be described.

The input AC power supply E is rectified in the full-wave rectifier DB1, and the rectified power supply voltage is supplied to the power supply circuit 18 and the power conversion circuit 16.

When the control unit IC2 of the power supply circuit 18 to which a power supply voltage is supplied starts an operation, the switching element of the control unit IC2 performs a switching operation, the first control power supply of which the ground potential is common to that of the power conversion circuit 16 is generated, and is supplied to the first control circuit 20 through the primary winding T31 of the transformer T3. In addition, due to flowing of the first control power supply, a second control power supply is induced to a secondary winding T32 which is insulated with respect to the primary winding T31 of the transformer T3, and is magnetically coupled thereto, and the second control power supply with an arbitrary ground potential which is different from that of the power conversion circuit 16 is supplied to the operation control circuit 22.

When the first control circuit 20 to which the first control power supply is supplied starts the operation, due to an operation signal from the microcomputer 31, a photo coupler PC103 as an insulation transmission element for controlling operation of the operation control circuit 22 is turned off, the transistor Q101 of the operation control circuit 22 is turned off, and the second control power supply is supplied to the second control circuit 21 through the operation control circuit 22.

When the second control circuit 21 to which the second control power supply is supplied starts the operation, the control unit IC1 turns ON and OFF the field effect transistor Q1 of the power conversion circuit 16.

When the field effect transistor Q1 is turned on, a current flows to the electrolytic capacitor C9 passing through the field effect transistor Q1, the resistor R28, and the inductor L5. When charging voltage of the electrolytic capacitor C9 becomes a forward voltage or more of the LED element 12, the current flows to the LED element 12, and the LED element 12 is turned on.

When the field effect transistor Q1 is turned off, energy which is accumulated in the inductor L5 is released in the closed circuit of the electrolytic capacitor C9, the LED element 12 and the diode D6. Due to a current which flows by the releasing of the energy, the LED element 12 is turned on.

Due to such an ON and OFF of the field effect transistor Q1, the field effect transistor Q1 performs a switching operation at a high frequency, and the LED element 12 is turned on.

The control unit IC1 performs a feedback control of ON and Off of the field effect transistor Q1 so that the output current of the power conversion circuit 16 becomes constant based on the detection voltage corresponding to the output current of the power conversion circuit 16.

In addition, the microcomputer 31 of the first control circuit 20, to which the dimming signal from the dimmer is input, outputs a dimming control signal corresponding to the dimming signal to the dimming operation circuit 23, and the dimming control signal is delivered to the second control circuit 21 through the photo coupler PC102. The second control circuit 21 controls ON and OFF of the field effect transistor Q1 according to the delivered dimming control signal, and performs dimming of the LED element 12.

In addition, in the dimming control, when a dimming OFF signal (lights out signal) is input, the power conversion circuit 16 outputs a power in which a voltage which substantially turns off the LED element by setting an applied voltage to the LED element 12 to be equal to or smaller than a voltage which cannot maintain lighting, while continuing the operation of the power conversion circuit 16 is applied. When the dimming ON signal is re-input after such a lights out mode, a stable control is maintained where the difference between the target value and an output detection value in the feedback control of the control circuit 21 is in a predetermined range, and it is possible to promptly perform a dimming operation based on the dimming signal.

In addition, the first control circuit 20 may perform a control so as to be moved to a standby mode due to an input of a predetermined processing signal or malfunction detection. In the standby mode, the photo coupler PC103 is turned on, the transistor Q101 of the operation control circuit 22 is turned on, and the supply of the second control power supply to the second control circuit 21 is stopped when a stop signal is output to the operation control circuit 22 from the microcomputer 31. For this reason, the power conversion circuit 16 to which the supply of the second control power supply is stopped is stopped, and the LED element 12 is completely turned off.

In this manner, in the power supply device 10, since the power supply circuit 18 converts the power supply voltage which is rectified in the rectifying circuit 15 into the second control power supply which is insulated with respect to the ground potential of the power conversion circuit 16, and supplies the second control power supply to the second control circuit 21, it is possible to efficiently supply the second control power supply to the second control circuit 21 which has a ground potential which is different from that of the ground potential of the power conversion circuit 16, and controls the power conversion circuit 16. For this reason, it is possible to correspond to a wide range of an input voltage of 100 V to 242 V, and to obtain high efficiency.

In addition, by adopting one power supply circuit 18, it is possible to supply the power supply voltage which is rectified in the rectifying circuit 15 to the first control circuit 20 by converting the power supply voltage into the first control power supply, and to supply the first control power supply to the second control circuit 21 by converting the power supply to the second control power supply which is insulated with respect to the ground potential of the power conversion circuit 16. Accordingly, it is possible to simplify the configuration.

In addition, since the power supply circuit 18 includes a switching element which converts the power supply voltage which is rectified in the rectifying circuit 15 into the first control power supply, and the transformer T3 which converts the first control power supply into the second control power supply, it is possible to obtain high power source conversion efficiency even if the input voltage is high, and to supply the second control power supply which is insulated with respect to the ground potential of the power conversion circuit 16 to the second control circuit 21.

In addition, since the operation control circuit 22 uses the photo coupler PC103, it is possible to transmit the operation control signal from the first control circuit 20 to the operation control circuit 22 while maintaining the first control circuit 20 and the second control circuit 21 having different potentials from each other in the insulating state.

Further, since the photo coupler PC103 is a switching element having temperature dependency in which the higher the temperature, the lower the current conversion rate, it is possible to stop the second control circuit 21 by performing de-energization of the second control circuit 21 when the power supply device 10 has an abnormally high temperature. Accordingly, it is also possible to have a so-called thermal shut down function.

In addition, since the dimming operation circuit 23 uses the photo coupler PC102, it is possible to transmit the dimming control signal to the second control circuit 21 from the first control circuit 20 while maintaining the first control circuit 20 and the second control circuit 21 having different potentials from each other in the insulating state.

In addition, as the insulation transmission element for dimming, for example, an element which magnetically transmits a signal, or the like, may be used without limiting to the photo coupler.

In addition, the control unit IC1 of the second control circuit 21 is input with a predetermined reference voltage at one input terminal of the operational amplifier, input with a detection voltage corresponding to the output current of the power conversion circuit 16 from an FB terminal at the other input terminal, and a current corresponding to a difference between the reference voltage and the detection voltage is output from the terminal A4. However, when a dimming level is deepened so that it becomes dark from an all lit state, the detection voltage which is input to the terminal A3 becomes closer to the reference voltage, and a current that flows from the terminal A4 becomes small. In addition, the control unit IC1 has a property of not operating when the current becomes a predetermined current value or less.

Due to such a property of the control unit IC1, at the time of inputting a power supply of the power supply device 10, when the first control circuit 20 outputs a dimming control signal of a dimming level which is set to the second control circuit 21, and the second control circuit 21 is to be started in the set dimming level, it takes time to start the second control circuit 21, and as a result, it takes time to turn on the LED element 12.

Therefore, the first control circuit 20 outputs a dimming control signal of all lighting to the second control circuit 21 when starting, and outputs a dimming control signal of a dimming level which is set after a predetermined start time from the starting to the second control circuit 21.

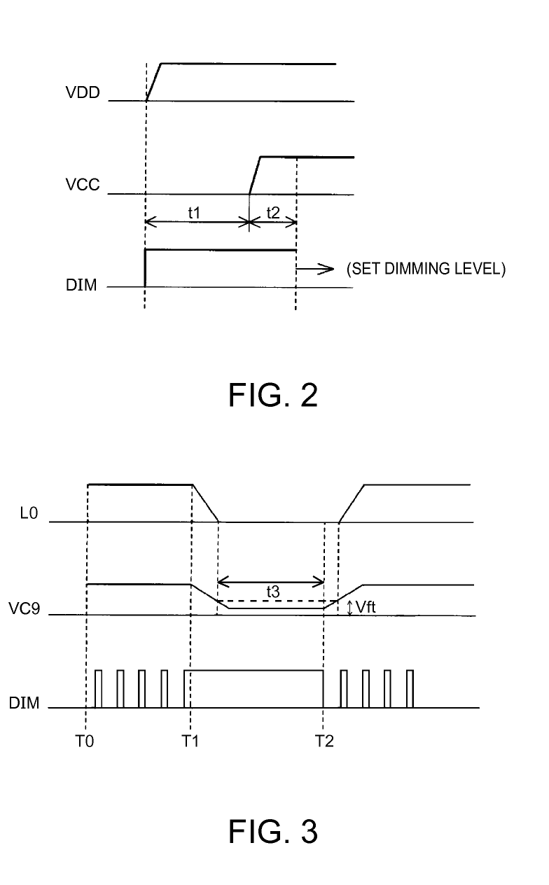

That is, as illustrated in FIG. 2, when the power supply VDD is input, the first control circuit 20 outputs the dimming OFF signal DIM for lights out to the second control circuit 21. Due to characteristics of the dimming control of the first control circuit 20, the power supply VCC of the control unit IC1 of the second control circuit 21 rises after a predetermined time t1 from inputting of the power supply VDD, and the operation thereof starts in the lights out state. After a predetermined start-up time t1+t2 (after predetermined time t2 from rising of power supply VCC of control unit IC1) from inputting of the power supply VDD, the first control circuit 20 outputs a dimming control signal DIM of a set dimming level to the second control circuit 21. Since an output current from the terminal A4 of the control unit IC1 is sufficiently increased up to that point, it is possible to shorten the start-up time of the second control circuit 21, and as a result, it is possible to shorten time up to turning on of the LED element 12.

In addition, it is possible for the first control circuit 20 to shorten the start-up time of the second control circuit 21 by adjusting the start-up time t1+t2 from inputting of the power supply VDD according to the set dimming level, and to prevent an occurrence of a flash of light due to full lighting at the time of start-up. In this case, the start-up time may be set to be longer, when the dimming level is deeper. The start-up time is equal to or less than two seconds at the most.

FIG. 3 is a timing chart which illustrates a relationship with a light output when a dimming OFF signal is input to the power supply device according to the embodiment. In FIG. 3, L0 denotes a light output level of the LED element 12, and VC9 denotes a potential which is applied to both ends of the LED element 12 (corresponding to voltage between both ends of electrolytic capacitor C9).

In time T0, a dimming ON signal is input from the dimming control signal DIM as a PWM signal, and the light output L0 of a level corresponding to the dimming signal is output from the LED element 12. The applied voltage VC9 to the LED element 12 at this time is a value with which a light output of a level corresponding to the dimming signal from the LED element 12 is possible.

The power conversion circuit 16 is controlled so that the applied voltage VC9 gradually decreases when the dimming OFF signal (PWM signal of duty 100%) is input in time T1, and the light output L0 of the LED element 12 also starts to decrease. When a voltage value is lower than the lower limit value Vft of a voltage value with which each element of the series body of the LED element 12 can be turned on, the LED element 12 is turned off, however, the power conversion circuit 16 continues the operation, and continuously outputs a voltage value which is lower than the lower limit value Vft. Since the voltage value which is lower than the lower limit value Vft is output from the power conversion circuit 16 in the period t3 in FIG. 3, the difference between the target value and the output detection value in the feedback control of the second control circuit is in a predetermined range, and a stable control is maintained. That is, even when the dimming ON signal is re-input at the time T2, it is possible for the second control circuit 21 to promptly transfer to a dimming operation corresponding to the dimming signal.

The power conversion circuit 16 is controlled so that the applied voltage VC9 gradually increases from the time T2, and the light output L0 of the LED element 12 starts to increase at the time the applied voltage VC9 exceeds the lower limit value Vft. In this manner, when the dimming OFF signal is input at the time T1, the LED element 12 performs a fadeout operation, and when the dimming OFF signal is released due to the input of the dimming ON signal, the LED element 12 performs a fade-in operation. Such fade-in processing, or fadeout processing can be performed by setting an algorithm in the microcomputer 31 of the first control circuit 20. However, the fade-in processing, or the fadeout processing may be executed by adding a sequence timer circuit to the control unit IC1 of the second control circuit 21.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power supply device comprising:
a power conversion circuit which outputs an input power to a load by converting the input power into a predetermined output power; and
a control circuit which performs a feedback control of the power conversion circuit by detecting the output power of the power conversion circuit, and performs a dimming control which causes the load to be subject to a dimming operation based on a dimming signal which is output from a dimmer,
wherein, when a dimming OFF signal is input, the power conversion circuit outputs power which causes the load to be turned off while continuing an operation of the power conversion circuit.

2. The device according to claim 1, further comprising:
a dimming control circuit which inputs the dimming signal which is output from the dimmer, and outputs a dimming control signal based on the dimming signal to the control circuit,
wherein the dimming control circuit outputs the dimming control signal with which the power conversion circuit outputs the power which causes the load to be turned off to the load while continuing the operation of the power conversion circuit when the dimming OFF signal is input.

3. The device according to claim 1,
wherein the load is configured of an LED, and an electrolytic capacitor is connected to the load in parallel.

4. The device according to claim 1,
wherein the power conversion circuit is controlled so that, when the dimming OFF signal is input, the load performs a fadeout operation, and when the dimming OFF signal is released, the load performs a fade-in operation.

5. The device according to claim 1,
wherein the power conversion circuit is controlled so that an applied voltage to the load decreases when the dimming OFF signal is input, and when the voltage is lower than a lower limit value of a voltage with which each load can be operated, the load is not operated, however, the power conversion circuit continues the operation, and continuously outputs a voltage of which a value is lower than the lower limit value.

6. A lighting device comprising:
a power supply device; and
a load,
wherein the power supply device includes
a power conversion circuit which outputs an input power to a load by converting the input power into a predetermined output power, and
a control circuit which performs a feedback control of the power conversion circuit by detecting the output power of the power conversion circuit, and performs a dimming control which causes the load to be subject to a dimming operation based on a dimming signal which is output from a dimmer, and
wherein, when a dimming OFF signal is input, the power conversion circuit outputs power which causes the load to be turned off while continuing an operation of the power conversion circuit.

7. The device according to claim 6, further comprising:
a dimming control circuit which inputs the dimming signal which is output from the dimmer, and outputs a dimming control signal based on the dimming signal to the control circuit,
wherein the dimming control circuit outputs the dimming control signal with which the power conversion circuit outputs the power which causes the load to be turned off to the load while continuing the operation of the power conversion circuit when the dimming OFF signal is input.

8. The device according to claim 6,
wherein the load is configured of an LED, and an electrolytic capacitor is connected to the load in parallel.

9. The device according to claim 6,
wherein the power conversion circuit is controlled so that, when the dimming OFF signal is input, the load performs a fadeout operation, and when the dimming OFF signal is released, the load performs a fade-in operation.

10. The device according to claim 6,
wherein the power conversion circuit is controlled so that an applied voltage to the load decreases when the dimming OFF signal is input, and when the voltage is lower than a lower limit value of a voltage with which each load can be operated, the load is not operated, however, the power conversion circuit continues the operation, and continuously outputs a voltage of which a value is lower than the lower limit value.
